(19) United States
(12) Patent Application Publication
(10) Pub. No.: US 2020/0361416 A1
(43) Pub. Date: Nov. 19, 2020

(54) VEHICULAR DEVICE AND NON-TRANSITORY TANGIBLE COMPUTER READABLE STORAGE MEDIUM

(71) Applicant: DENSO CORPORATION, Kariya-city (JP)

(72) Inventor: Nobuhiro OGURA, Kariya-city (JP)

(21) Appl. No.: 16/985,568

(22) Filed: Aug. 5, 2020

Related U.S. Application Data
(63) Continuation of application No. PCT/JP2018/044003, filed on Nov. 29, 2018.

(30) Foreign Application Priority Data
Feb. 13, 2018 (JP) 2018-023021

(51) Int. Cl. B60R 25/31; B60R 25/04; B60Q 9/00; G01C 21/36

(52) U.S. Cl. CPC B60R 25/31; B60R 25/04; G06F 3/041; G01C 21/3626; B60Q 9/00

(57) ABSTRACT

A vehicular device includes: a first controller configured to detect a user entry and exit of a vehicle and an engine start and stop and to switch between a system nonoperational state and a system operational state; and a second controller configured to control a function start and stop. When the first controller detects a user action to turn off the engine and to exit from the vehicle while the vehicular device is in the system operational state, the second controller stops a function with maintaining the system operational state. When the first controller detects the user action to re-entry into the vehicle and to turn on the engine before a predefined time interval elapses from the user action to turn off the engine and to exit from the vehicle, the second controller restarts the function.

### CROSS REFERENCE TO RELATED APPLICATION

The present application is a continuation application of International Patent Application No. PCT/JP2018/044003 filed on Nov. 29, 2018, which designated the U.S. and claims the benefit of priority from Japanese Patent Application No. 2018-023021 filed on Feb. 13, 2018. The entire disclosures of all of the above applications are incorporated herein by reference.

### TECHNICAL FIELD

The present disclosure relates to a vehicular device, and a non-transitory tangible computer readable storage medium.

### BACKGROUND

Vehicle devices installed in vehicles have been providing increasingly advanced functionality, which has been leading to increase in size and type of programs read by the device at startup. Thus, a system starting time is on the increase that is a time required from when a user enters the vehicle and turns on the engine until the device starts providing functions. As a solution, a configuration has been proposed that includes a main microcomputer requiring a relatively long starting time and a sub-microcomputer requiring a relatively short starting time. The sub-microcomputer provides functions from when the accessory power (hereinafter referred to as ACC) is turned on until the main microcomputer's starting operation is completed. A device configured to provide an initial screen can thereby provide the initial screen swiftly when the user enters the vehicle and turns on the engine, which in turn turns on ACC.

### SUMMARY

A vehicular device includes: a first controller configured to detect a user entry and exit of a vehicle and an engine start and stop and to switch between a system nonoperational state and a system operational state; and a second controller configured to control a function start and stop. When the first controller detects a user action to turn off the engine and to exit from the vehicle while the vehicular device is in the system operational state, the second controller stops a function with maintaining the system operational state. When the first controller detects the user action to re-entry into the vehicle and to turn on the engine before a predefined time interval elapses from the user action to turn off the engine and to exit from the vehicle, the second controller restarts the function.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a functional block diagram of an embodiment;

FIG. 2 is a diagram illustrating a main microcomputer and a sub-microcomputer; and

FIG. 3 is a state transition diagram.

### DETAILED DESCRIPTION

A conceivable configuration includes a main microcomputer and sub-microcomputer having different starting times. A user key unlocking operation causes a system nonoperational state to transition to a system standby state in which ACC is monitored. ACC turning on causes the system standby state to transition to a system operational state when the main microcomputer starts the normal operation.

In the above conceivable configuration, a user operation to turn off the engine and exit from the vehicle turns off both ACC and the ignition power (hereinafter referred to as IG), causing the system operational state to transition to the system nonoperational state. A subsequent user re-entry into the vehicle and operation to turn on the engine turns on both ACC and IG. In this case, the system starting operation has to be started from the system nonoperational state, which has been present since the previous operation to turn off the engine. Since the system starting operation is started from the system nonoperational state, the system starting time is prolonged. If the length of time from a user exit from the vehicle to a re-entry into the vehicle is relatively long, the prolonged system starting time is expected not to cause the user to feel inconvenience. If, however, the length of time from a user exit to a re-entry is relatively short, the prolonged system starting time is expected to cause the user to feel inconvenience.

In view of the above point a vehicle device, functional control program, and state transition control program are provided such that the device can shorten a system starting time when the length of time from a user operation to turn off the engine and exit from the vehicle to a re-entry into the vehicle and operation to turn on the engine is relatively short, thereby capable of enhancing convenience.

According to an example embodiment, a first controller is configured to detect a user entry into or exit from a vehicle and an engine being on or off and cause the device to transition between a system nonoperational state and a system operational state. A second controller can control a function to start or stop when the device is in the system operational state. When the first controller detects a user operation to turn off the engine and exit from the vehicle with the device in the system operational state, the second controller stops a function with the device remaining in the system operational state. When the first controller detects a user re-entry into the vehicle and operation to turn on the engine before a predefined time elapses from time of the detection by the first controller of the user operation to turn off the engine and exit from the vehicle, the second controller restarts the function that has been stopped.

A user operation to turn off the engine and exit from the vehicle causes a function to stop with the device remaining in the system operational state, instead of causing the device to transition from the system operational state to the system nonoperational state. A subsequent user re-entry into the vehicle and operation to turn on the engine before the elapse of a predefined time from the time of the user operation to turn off the engine and exit from the vehicle causes the function that has been stopped to restart. The system starting time can thus be shorted when the length of time from a user operation to turn off the engine and exit from the vehicle to a user re-entry into the vehicle and operation to turn on the engine is relatively short, and therefore convenience can be enhanced.

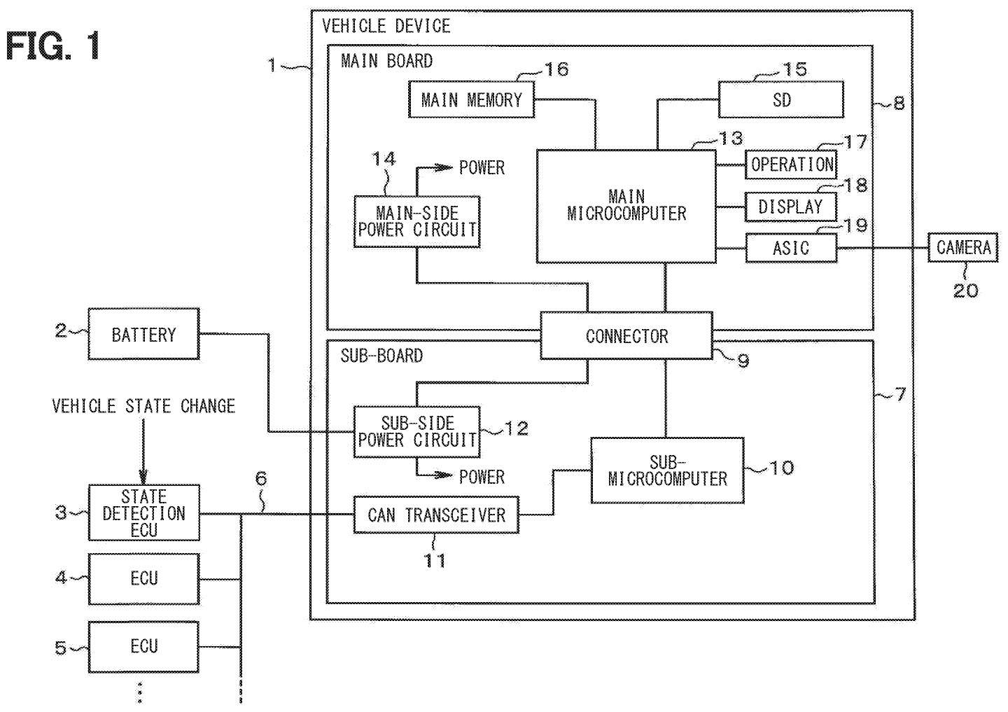

An embodiment is described below with reference to the drawings. As illustrated in FIG. 1, a vehicle device 1 mounted to a vehicle is supplied with power from a battery 2. The vehicle device 1 may be fixedly or removably mounted to the vehicle. In addition to the vehicle device 1, different types of devices such as a state detection ECU (electronic control unit) 3 and ECUs 4 and 5 are mounted to the vehicle. The ECUs 3 to 5 are connected to the vehicle device 1 through a communication bus 6 configured using, for example, a CAN (controller area network, a registered trademark) in a manner that allows data communication. While the present embodiment provides an example in which the communication bus 6 is configured using a CAN, the communication bus 6 may be configured using, for example, a LIN (local interconnect network), CXPI (clock extension peripheral interface, a registered trademark), FlexRay (a registered trademark), MOST (media oriented systems transport, a registered trademark), or the like.

The state detection ECU 3 detects a vehicle state change and transmits a data frame that can identify the detected vehicle state change to the communication bus 6. A vehicle state change refers to a change corresponding to a user operation made to the vehicle, including opening of a door, unlocking using a remote key, turning on or off of an accessory power (hereinafter referred to as ACC), and turning on or off of an ignition power (hereinafter referred to as IG).

The vehicle device 1 includes a sub-board 7 and a main board 8. The sub-board 7 and the main board 8 are physically coupled to each other via a connector 9 and configured to allow for supply of power and communication of data via the connector 9.

The sub-board 7 includes a sub-microcomputer 10 (corresponding to a first controller), a CAN transceiver 11, and a sub-side power circuit 12 mounted thereon. The sub-side power circuit 12 receives power from the battery 2 and supplies power to each functional block mounted on the sub-board 7 and to the main board 8. The CAN transceiver 11 receives power from the sub-side power circuit 12 at all times to monitor whether a data frame flows through the communication bus 6. On detecting a data frame flowing through the communication bus 6, the CAN transceiver 11 receives the data frame and outputs it to the sub-microcomputer 10. A data frame specified for a CAN, which is widely known and is not described in detail herein, includes an identifier (ID), a data field, and so forth.

The sub-microcomputer 10 is a microcomputer that controls power and includes a CPU (central processing unit), a ROM (read only memory), a RAM (random access memory), an I/O (input/output), and so forth. The sub-microcomputer 10 executes a program stored in a non-transitory tangible storage medium and performs a process corresponding to the program. Programs executed by the sub-microcomputer 10 include a state transition control program. The sub-microcomputer 10 transitions between a nonoperational state and an operational state. When being in the nonoperational state and receiving a specific data frame from the CAN transceiver 11, the sub-microcomputer 10 is prompted to transition to the operational state.

The main board 8 includes: a main microcomputer 13 (corresponding to a second controller); a main-side power circuit 14; an SD (Secure Digital) 15 configured by using, for example, a semiconductor memory; a main memory 16 configured by using, for example, a DDR (double data rate) memory; an operation portion 17; a display portion 18; and an image processing ASIC (application specific integrated circuit) 19, mounted thereon.

The main-side power circuit 14 receives power from the sub-side power circuit 12 via the connector 9 and supplies power to each functional block mounted on the main board 8. The main-side power circuit 14 starts the power supply in response to the main microcomputer 13 receiving a start command from the sub-microcomputer 10. The main-side power circuit 14 also serves as a reset circuit for the main microcomputer 13. The main-side power circuit 14 also functions to regulate supply power according to a load state of the main microcomputer 13. Specifically, if determining that the main microcomputer 13 is in a low load state, the main-side power circuit 14 decreases supply power to the main microcomputer 13, giving higher priority to power conservation. If determining that the main microcomputer 13 is in a high load state, the main-side power circuit 14 increases supply power to the main microcomputer 13, giving higher priority to processing speed.

The main microcomputer 13 is a microcomputer that controls HMI and performs function control, and includes a CPU, a ROM, a RAM, an I/O, and so forth. The main microcomputer 13 executes a program stored in a non-transitory tangible storage medium and performs a process corresponding to the program. Programs executed by the sub-microcomputer 10 include a functional control program. The main microcomputer 13 transitions between a nonoperational state and an operational state. When transitioning from the nonoperational state to the operational state, the main microcomputer 13 reads a program from the SD 15 and loads it to the main memory 16 for execution. The main microcomputer 13 executing programs enables the vehicle device 1 to provide different functions.

The operation portion 17 is configured using a touch panel on a display screen of the display portion 18 and mechanical switches provided near the display screen. On detecting a user operation to the vehicle device 1, the operation portion 17 outputs an operation detection signal indicative of the user operation to the main microcomputer 13. Specifically, when a user operates a touch key displayed in the touch panel, the operation portion 17 outputs an operation detection signal indicative of a touch key operation to the main microcomputer 13. A user operation on a hard key, one of the mechanical switches, causes the operation portion 17 to output an operation detection signal indicative of a hard key operation to the main microcomputer 13.

The display portion 18 is configured using, for example, a liquid crystal display, a backlight, and so forth and is in a location such as in a center console of the vehicle. A user can see what is displayed in the liquid crystal display when the backlight is on and cannot when the backlight is off.

A camera 20 is mounted to the vehicle so as to be able to image a driver blind spot located in areas such as behind and beside the vehicle. The camera 20 images such areas and outputs the image data to the ASIC 19. On receiving the image data from the camera 20, the ASIC 19 image-processes the data and adds information such as, for example, a marking indicative of a vehicle width to the image-processed data. Displaying an image obtained by the camera 20 with additional information, such as the marking, superposed thereon in the display portion 18 enables a driver to recognize the situation in a driver blind spot in areas such as behind and beside the vehicle.

In the present embodiment, two boards, namely the sub-board 7 and the main board 8, are provided so that the sub-microcomputer 10 and the main microcomputer 13 are provided on separate boards. In this manner, the main board 8 can be replaced with another one having a different function with the common sub-board 7 remaining in place. Note that the sub-microcomputer 10 and the main microcomputer 13 do not necessarily have to be placed on separate boards. The sub-microcomputer 10 and the main microcomputer 13 may be placed on an identical board.

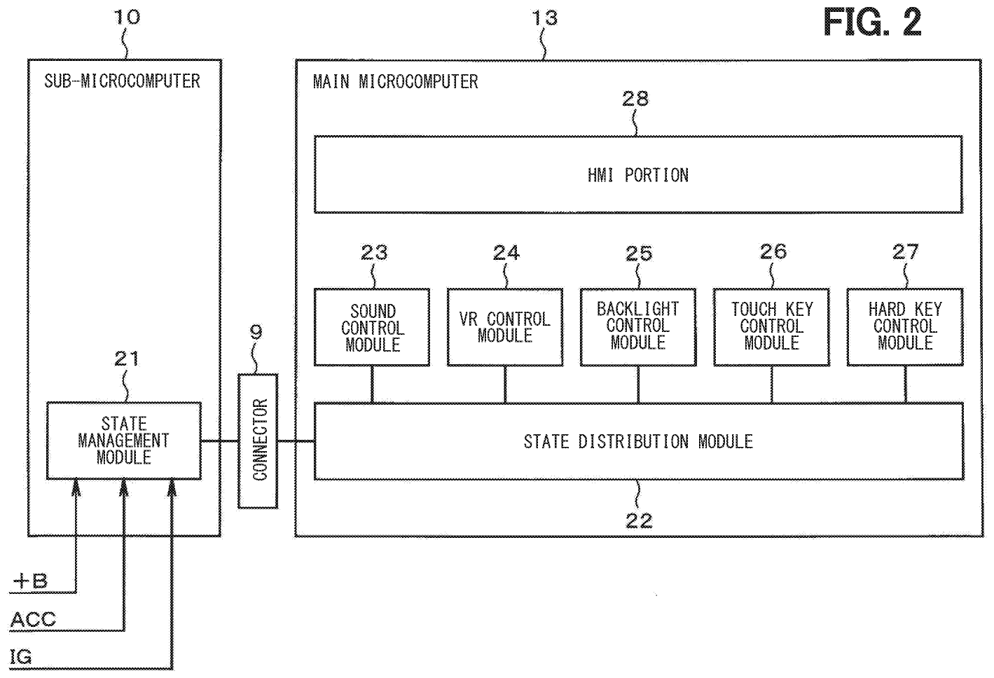

The sub-microcomputer 10 and the main microcomputer 13 are described next below. As illustrated in FIG. 2, the sub-microcomputer 10 includes a state management module 21. The state management module 21 receives power (+B) from the battery 2, and determines whether ACC is on or off and IG is on or off based on a data frame received from the state detection ECU 3 via the CAN transceiver 11. The state management module 21 manages the state of the vehicle device 1 based on a result of the determination of whether ACC is on or off and IG is on or off, and feeds a state notification signal indicative of a state of the vehicle device 1 to the main microcomputer 13.

The main microcomputer 13 includes a state distribution module 22, a sound control module 23, a virtual reality control module (hereinafter referred to as VR control module) 24, a backlight control module 25, a touch key control module 26, a hard key control module 27, and an HMI portion 28. When receiving a state notification signal from the sub-microcomputer 10, the state distribution module 22 outputs a start command or stop command depending on the content of the state notification signal received, to each of the control modules 23 to 27.

If receiving a start command from the state distribution module 22, the sound control module 23 starts a sound function of an audio and/or a navigation. If receiving a stop command from the state distribution module 22, the sound control module 23 stops the sound function of the audio and/or the navigation. If receiving a start command from the state distribution module 22, the VR control module 24 starts a VR function. If receiving a stop command from the state distribution module 22, the VR control module 24 stops the VR function. If receiving a start command from the state distribution module 22, the backlight control module 25 turns on the backlight. If receiving a stop command from the state distribution module 22, the backlight control module 25 turns off the backlight. If receiving a start command from the state distribution module 22, the touch key control module 26 activates a touch key. If receiving a stop command from the state distribution module 22, the touch key control module 26 deactivates the touch key. If receiving a start command from the state distribution module 22, the hard key control module 27 activates a hard key. If receiving a stop command from the state distribution module 22, the hard key control module 27 deactivates the hard key.

In the configuration described above, the main microcomputer 13 is required to read an operating system (OS) for achieving the functionality provided by the vehicle device 1 at startup and programs that are relatively large in scale, such as an image processing program. If the ASIC 19 is included as in the present embodiment, the main microcomputer 13 is also required to perform processes such as initializing the ASIC 19. If a navigation function is included as in the present embodiment, the main microcomputer 13 is further required to perform processes such as generating a map screen from map data and calculating a guide route from link information. The main microcomputer 13 is also required to read a navigation program, which is relatively large in scale. Due to reasons as described above, the main microcomputer 13 has a longer starting time than the sub-microcomputer 10.

If a configuration is included to provide an image of a driver blind spot as in the present embodiment, a greater contribution can be made to safety with a shorter length of time from a user entry into the vehicle and operation to turn on the engine to the presentation of the image on the display. That is, a greater contribution can be made to safety with a shorter length of time from when a user starts operating to start the vehicle to when safety check capability in areas such as behind and beside the vehicle becomes available to the user. If a navigation function is included as in the present embodiment, a greater contribution can be made to convenience with a shorter length of time from a user entry into the vehicle and operation to turn on the engine to a user input of a destination and the like. Thus, the increase in size and type of programs read by the main microcomputer 13 at startup as described above presents difficulty in improving safety and convenience.

When driving a vehicle, a user may, for example, make a stop at a store. In such a situation, the length of time may be as short as a few minutes from a user operation to turn off the engine and exit from the vehicle to a re-entry into the vehicle and operation to turn on the engine. If the system starting operation is started from the system nonoperational state in this case, the system starting time is prolonged. The prolonged starting time is expected to cause a user to feel inconvenience. The vehicle device 1 in the present embodiment operates as described below to shorten the system starting time when the length of time from a user operation to turn off the engine and exit from the vehicle to a user re-entry into the vehicle and operation to turn on the engine is relatively short.

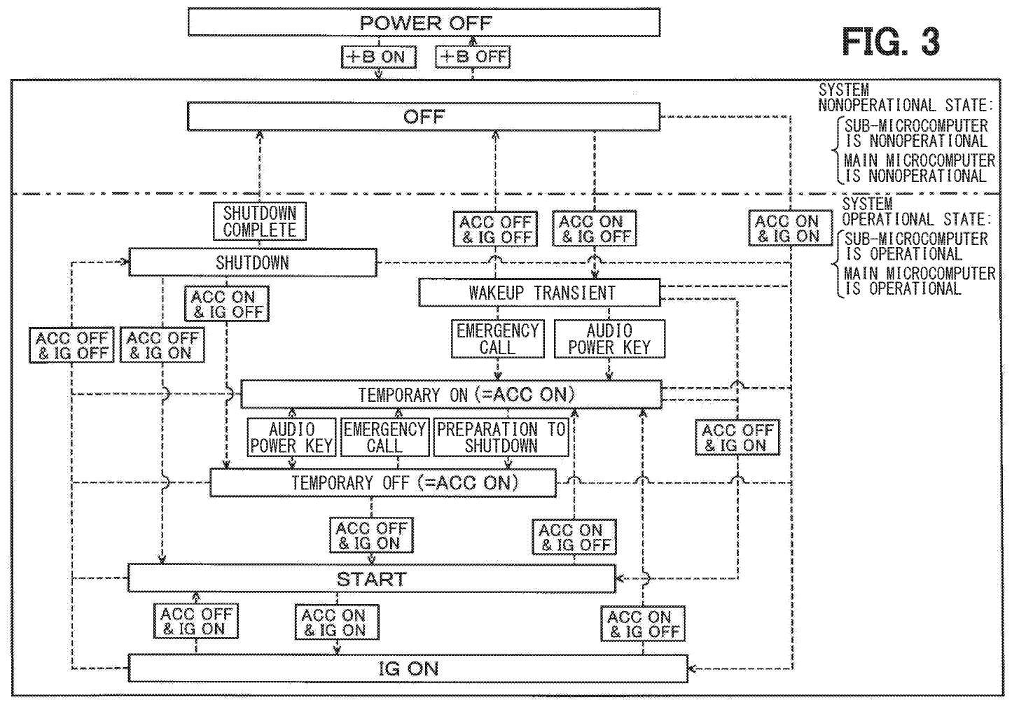

An operation of the configuration described above is explained next with reference to FIG. 3.

As illustrated in FIG. 3, when the vehicle device 1 receives power from the battery 2 (+B ON), the state management module 21 manages the operational state of the vehicle device 1 in two states, a system nonoperational state (OFF) and a system operational state. The state management module 21 causes the vehicle device 1 to transition between the system nonoperational state and the system operational state.

In the system nonoperational state, both ACC and IG are off, with the sub-microcomputer 10 and the main microcomputer 13 both being in a nonoperational state. Note that the CAN transceiver 11, which is supplied with power at all times, is operational in the system nonoperational state, and monitors whether data flows through the communication bus 6.

A user entry into the vehicle and operation to turn on the engine with the vehicle device 1 being in the system nonoperational state turns both ACC and IG on. When detecting ACC being on and IG being on based on a data frame from the CAN transceiver 11, the state management module 21 causes the vehicle device 1 to transition from the system nonoperational state to the system operational state into an IG ON state, and feeds an IG ON state notification signal indicative of a transition to the IG ON state to the state distribution module 22.

When receiving the IG ON state notification signal from the state management module 21, the state distribution module 22 starts outputting a start command to each of the control modules 23 to 27. When the control modules 23 to 27 start receiving the start command from the state distribution module 22, the control modules 23 to 27 start respective functions. That is, the sound function of the audio and/or the navigation is started, the VR function is started, the backlight is turned on, the touch key is activated, and the hard key is activated. In this manner, each function becomes available.

A user operation to turn off the engine in this state causes IG to turn off but ACC to remain on. When detecting ACC being on and IG being off based on a data frame from the CAN transceiver 11, the state management module 21 causes the vehicle device 1 to transition from the IG ON state to a temporary ON state.

A user opening a door to exit the vehicle in this state causes a preparation-to-shutdown to occur. When detecting the occurrence of the preparation-to-shutdown, the state management module 21 causes the vehicle device 1 to transition from the temporary ON state to a temporary OFF state, and feeds a temporary OFF state notification signal indicative of a transition to the temporary OFF state to the state distribution module 22. The state management module 21 starts timing to measure a time elapsed from the time of the transition of the vehicle device 1 from the temporary ON state to the temporary OFF state. That is, the state management module 21 measures a time elapsed with the vehicle device 1 in the temporary OFF state.

When receiving the temporary OFF state notification signal from the state management module 21, the state distribution module 22 stops outputting a start command and starts outputting a stop command to each of the control modules 23 to 27 (corresponding to a function stop procedure). When the control modules 23 to 27 start receiving the stop command from the state distribution module 22, the control modules 23 to 27 stop respective functions. That is, the sound function of the audio and/or the navigation is stopped, the VR function is stopped, the backlight is turned off, the touch key is deactivated, and the hard key is deactivated. In this manner, each function is made unavailable, and a user can recognize the unavailability of the functions.

A user re-entry into the vehicle and operation to turn on the engine in this state causes IG to turn on. When detecting ACC being on and IG being on based on a data frame from the CAN transceiver 11 before the time elapsed in the temporary OFF state reaches a predefined time, the state management module 21 causes the vehicle device 1 to transition from the temporary OFF state to the IG ON state, and feeds the IG ON state notification signal indicative of a transition to the IG ON state to the state distribution module 22. If cranking occurs here, ACC is temporarily turned off. When detecting ACC being off and IG being on based on a data frame from the CAN transceiver 11, the state management module 21 causes the vehicle device 1 to transition from the temporary OFF state to a start state for a time. Subsequently, when detecting ACC being on and IG being on based on a data frame from the CAN transceiver 11, the state management module 21 causes the vehicle device 1 to transition from the start state to the IG ON state. The predefined time may be a fixed value or a variable value arbitrarily settable by a user.

When causing the vehicle device 1 to transition from the temporary OFF state to the IG ON state, or to the start state, the state management module 21 feeds the IG ON state notification signal indicative of a transition to the IG ON state, or a start state notification signal indicative of a transition to the start state, to the state distribution module 22.

When receiving the IG ON state notification signal or the start state notification signal from the state management module 21, the state distribution module 22 stops outputting a stop command and starts outputting a start command to each of the control modules 23 to 27 (corresponding to a function restart procedure). When the control modules 23 to 27 start receiving the start command from the state distribution module 22, the control modules 23 to 27 start respective functions. That is, the sound function of the audio and/or the navigation is started, the VR function is started, the backlight is turned on, the touch key is activated, and the hard key is activated. In this manner, each function becomes available.

As described above, a user operation to turn off the engine and exit from the vehicle with the vehicle device 1 in the IG ON state causes the vehicle device 1 to transition from the IG ON state to the temporary ON state and then from the temporary ON state to the temporary OFF state, instead of causing the vehicle device 1 to transition from the IG ON state to the system nonoperational state. In this manner, each function can be made unavailable and a user can recognize the unavailability of the functions while the vehicle device 1 remains in the system operational state. A subsequent user re-entry into the vehicle and operation to turn on the engine causes a transition from the temporary OFF state to the IG ON state if the time elapsed in the temporary OFF state has not reached the predefined time. Thus, the starting operation does not have to be started in the system nonoperational state. The starting operation can be started in the system operational state, and thereby the system starting time can be shortened.

If the time elapsed in the temporary OFF state reaches the predefined time without a user re-entry into the vehicle, ACC is turned off. The state management module 21 thus detects ACC being off and IG being off when the time elapsed in the temporary OFF state reaches the predefined time before the detection of ACC being on and IG being on based on a data frame from the CAN transceiver 11 (corresponding to a time elapse determination procedure). In this case, the state management module 21 causes the vehicle device 1 to transition from the temporary ON state to a shutdown state (corresponding to a state transition procedure). When detecting a completed shutdown, the state management module 21 causes the vehicle device 1 to transition from the shutdown state to the system nonoperational state.

If the state management module 21 detects occurrence of an emergency call or an operation on an audio power key with the vehicle device 1 being in a wakeup transient state, the state management module 21 causes the vehicle device 1 to transition to the temporary ON state. If the state management module 21 detects occurrence of an emergency call or an operation on the audio power key with the vehicle device 1 being in the temporary OFF state, the state management module 21 also causes the vehicle device 1 to transition to the temporary ON state. If the state management module 21 detects an operation on the audio power key with the vehicle device 1 being in the temporary ON state, the state management module 21 causes the vehicle device 1 to transition to the temporary OFF state.

As described above, the present embodiment can produce the following effects.

A user operation to turn off the engine and exit from the vehicle causes a function to stop with the vehicle device 1 remaining in the system operational state, instead of causing the vehicle device 1 to transition from the system operational state to the system nonoperational state. A subsequent user re-entry into the vehicle and operation to turn on the engine before the elapse of a predefined time from the time of the user operation to turn off the engine and exit from the vehicle causes the function that has been stopped to restart. The system starting time can thus be shorted when the length of time is relatively short from a user operation to turn off the engine and exit from the vehicle to a user re-entry into the vehicle and operation to turn on the engine, and therefore convenience can be enhanced.

When the elapse of the predefined time from the time of the detection of the user operation to turn off the engine and exit from the vehicle with the device in the system operational state is detected before a user re-entry into the vehicle and operation to turn on the engine, the vehicle device 1 is caused to transition from the system operational state to the system nonoperational state. The possibility of the vehicle device 1 to be locked in the temporary OFF state can be averted in this manner, and thus unnecessary power consumption can be curbed by causing the vehicle device 1 to transition from the system operational state to the system nonoperational state.

Furthermore, when the vehicle device 1 is caused to transition to the temporary OFF state, the sound function of the audio and/or the navigation is stopped, the VR function is stopped, the backlight is turned off, the touch key is deactivated, and the hard key is deactivated. By stopping the sound function of the audio and/or the navigation, stopping the VR function, turning off the backlight, deactivating the touch key, and deactivating the hard key, a user can recognize the unavailability of the functions.

While the present disclosure has been described based on an embodiment, the present disclosure is not limited to the embodiment or structure described herein. The present disclosure encompasses various modifications and equivalent modifications. Additionally, various combinations and configurations, as well as other combinations and configurations including more, less, or only a single element, are within the scope and spirit of the present disclosure.

While a configuration has been described in which the CAN transceiver 11 and the sub-microcomputer 10 are provided separately, a microcomputer having the function of the CAN transceiver 11 may be provided as the sub-microcomputer. In such cases, the sub-microcomputer will have to perform the process of receiving data frames, which does not require a significantly higher functionality microcomputer. Thus, a possible increase of power consumption can be avoided even if the sub-microcomputer is energized at all times.

While the state distribution module 22 performs all of causing the sound function of the audio and/or the navigation to stop, the VR function to stop, the backlight to turn off, the touch key to be deactivated, and the hard key to be deactivated when the vehicle device 1 is caused to transition to the temporary OFF state, the state distribution module 22 may perform some of the above. The state distribution module 22 may cause other functions to stop or deactivated.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicular device comprising:
a first controller configured to detect a user entry into or exit from a vehicle and an engine start and stop and to switch the vehicular device between a system nonoperational state and a system operational state; and
a second controller arranged independently from the first controller and configured to control a function start and stop when the vehicular device is in the system operational state, wherein:
when the first controller detects a user action to turn off the engine and to exit from the vehicle while the vehicular device is in the system operational state, the second controller stops a function with maintaining the vehicular device in the system operational state; and
when the first controller detects the user action to re-entry into the vehicle and to turn on the engine before a predefined time interval elapses from when the first controller detects the user action to turn off the engine and to exit from the vehicle, the second controller restarts the function that has been stopped.

2. The vehicular device according to claim 1, wherein:
the first controller is provided by a processor; and
the second controller is provided by another processor.

3. The vehicle device according to claim 1, wherein:
when the first controller detects that the predetermined time interval elapses from when the first controller detects the user action to turn off the engine and to exit from the vehicle while the vehicular device is in the system operational state before the first controller detects the user action to re-entry into the vehicle and to turn on the engine, the first controller switches the vehicular device from the system operational state to the system nonoperational state.

4. The vehicle device according to claim 1, wherein:
as the control of the function start and stop, the second controller performs at least one of: a start and stop of a sound function of an audio and a navigation; a start and stop of a virtual reality function; a turn on and off of a backlight; an activation and deactivation of a touch key; and an activation and deactivation of a hardware key.

5. A non-transitory tangible computer readable storage medium comprising instructions being executed by a computer, the instructions including a computer-implemented method for controlling a function to cause a second controller, which is disposed in a vehicular device including: a first controller configured to detect a user entry into or exit from a vehicle and an engine start and stop and to switch the vehicular device between a system nonoperational state and a system operational state; and the second controller arranged independently from the first controller and configured to control a function start and stop when the vehicular device is in the system operational state, to provide at least:
a function stop procedure of stopping a function with maintaining the vehicular device in the system operational state when the first controller detects a user action to turn off the engine and to exit from the vehicle while the vehicular device is in the system operational state; and
a function restart procedure of restarting the function that has been stopped when the first controller detects the user action to re-entry into the vehicle and to turn on the engine before a predefined time interval elapses from when the first controller detects the user action to turn off the engine and to exit from the vehicle.

6. A non-transitory tangible computer readable storage medium comprising instructions being executed by a computer, the instructions including a computer-implemented method for controlling a state transition to cause a first controller, which is disposed in a vehicular device including: the first controller configured to detect a user entry into or exit from a vehicle and an engine start and stop and to switch the vehicular device between a system nonoperational state and a system operational state; and a second controller arranged independently from the first controller and configured to control a function start and stop when the vehicular device is in the system operational state, to provide at least:
a time elapse determination procedure of determining whether a predefined time elapses from when the first controller detects a user action to turn off the engine and to exit from the vehicle while the vehicular device is in the system operational state before the first controller detects the user action to re-entry into the vehicle and to turn on the engine; and
a state transition procedure of switching the vehicular device from the system operational state to the system nonoperational state when the first controller detects in the time elapse determination procedure that the predetermined time interval elapses.
